(19) United States
(12) Patent Application Publication
(10) Pub. No.: US 2021/0204577 A1
(43) Pub. Date: Jul. 8, 2021

(54) SYSTEM AND METHOD FOR USING CALCIUM CHLORIDE TO CREATE A FLAVORED TOMATO PRODUCT

(71) Applicant: NR INSTANT PRODUCE PUBLIC COMPANY LIMITED, Samut Sakhon (TH)

(72) Inventors: James Albert Corwell, IV, San Francisco, CA (US); David Benzaquen, New York, NY (US)

(21) Appl. No.: 17/097,076

(22) Filed: Nov. 13, 2020

Related U.S. Application Data
(60) Provisional application No. 62/934,629, filed on Nov. 13, 2019.

(51) Int. Cl. A23L 19/00; A23L 5/10; A23L 5/20; A23B 7/045; A23B 7/157

(52) U.S. Cl. CPC A23L 19/03; A23L 5/13; A23L 5/20; A23V 2002/00; A23B 7/157; A23L 19/09; A23B 7/045

(57) ABSTRACT

A method for preparing seafood alternatives from vegetation is provided. The method includes preparing the vegetation, wherein the preparing the vegetation includes cutting the vegetation into two or more pieces, brining the vegetation in a brining solution, cooking the vegetation, and marinating the vegetation in a marinade configured to give the vegetation a seafood flavor.

### CLAIM OF PRIORITY

This application is a United States non-provisional application which claims priority to U.S. Provisional Application No. 62/934,629 filed Nov. 13, 2019. The disclosure of which is incorporated herein by reference.

### FIELD OF THE EMBODIMENTS

This invention relates to seafood substitutes and, in particular, to a method of preparing a seafood alternative food from fruits and vegetables such as, e.g., tomatoes, eggplants, carrots, and Jack fruit.

### BACKGROUND OF THE EMBODIMENTS

Fish has been a staple of the human diet since antiquity. Sushi and sashimi, styles of preparing fish for consumption, is an ever-popular foodstuff. However, it is not always desirable, or sustainable, to consume real fish. There are many reasons why someone may not wish to consume fish.

There are many individuals who refrain from consuming fish for moral, religious, and/or humane reasons. There are also many individuals who refrain from consuming fish, or other forms of seafood, for health reasons, either due to allergies and/or chemicals found in the seafood. Furthermore, there are also many individuals who refrain from consuming fish for environmental reasons. Overfishing is damaging once healthy populations of sea life and causing many species to go extinct or face the possibility of going extinct.

For at least these reasons, a fish-free and sustainable substitute to consuming fish, while maintaining the same great taste that many people love, is needed.

Examples of related are described below:

U.S. Pat. No. 2,437,937 generally describes a process for treating tomatoes for packing and canning.

U.S. Pat. No. 2,492,735 generally describes firming agents, and more particularly to a firming agent for use in canning vegetables and fruits.

U.S. Pat. No. 5,332,589 generally describes a process for preparing fruits or vegetables and the fruits or vegetables prepared by the process. In particular, the vegetables may be diced tomatoes. The process comprises continuously exposing the diced fruits or vegetables to a calcium chloride solution comprising fruit or vegetable juice. The fruits or vegetables are exposed to the solution for a predetermined period of time. Calcium chloride solution is continuously recovered, measured and compared to a predetermined value or programmable controller microprocessor set-point. Any necessary adjustments are made to maintain the concentration within the accepted range of a predetermined value. The adjusted solution continuously feeds a nozzle bathing the diced fruits or vegetables.

U.S. Pat. No. 6,265,014 generally describes a process for the preparation of candied tomato pieces, in which tomatoes are peeled and cut into pieces, the pieces are sprinkled with a mixture based on sugar and salt, and then cooked. The invention also relates to candied tomato pieces prepared according to the process and food products containing the candied tomato pieces.

U.S. Pat. No. 6,159,512 generally describes a package of exposed fresh fruit including cut pieces of fruit, a packaging material and an edible gel. The packaging material encloses the fruit and allows transmission of oxygen and carbon dioxide to maintain an atmosphere about the fruit of at least 2% oxygen. The edible gel coats exposed surfaces of the fruit. The gel coating includes an anti-oxidant to retard browning and sufficient acidic constituents to establish and maintain on the exposed surfaces of the fruit a pH below 3.

U.S. Pat. No. 5,869,122 generally describes a process for enhancing the consistency of a macerated fruit or vegetable product by macerating a fruit or vegetable material to almost completely disrupt cellular material therein; adding calcium chloride to the fruit or vegetable material in an amount sufficient to increase consistency after subsequent heat treatment of the material; and heat treating the calcium chloride containing fruit or vegetable material for a sufficient time and at a sufficient temperature to inactivate pectin or other carbohydrate polymer degrading enzymes therein to form a macerated fruit or vegetable product with enhanced consistency. For optimum results, the calcium chloride is added to the macerated material within 1 minute after maceration and the heat treating is conducted within 1 minute after the addition of the calcium chloride.

U.S. Pat. No. 4,079,152 generally describes a controlled atmosphere package for retarding the ripening rate of tomatoes is formed from a gas permeable film which allows the tomatoes to convert the package atmosphere to an environment containing 0 to 10 vol. % carbon dioxide and 2.5 to 10 vol. % oxygen. The package contains chemical agents capable of absorbing moisture and carbon dioxide from the package environment so as to prevent mold growth or injury to the tomatoes.

U.S. Pat. No. 2,534,263 generally describes treatments of fruits and vegetables, and more particularly, to methods of improving the consistency of processed vegetable and fruit products.

U.S. Pat. No. 2,549,781 generally describes a process for the canning of fruits and vegetables, and particularly to an improved method for obtaining a firming thereof and for handling the firming agent in the dry form.

U.S. Patent Publication No. 2004/0065094 generally describes a process for the production of a frozen vegetable or part thereof, wherein said process comprises the steps: (i) subjecting a vegetable or part thereof to a firming treatment selected from: a) immersing the vegetable or part thereof in a solution of a calcium salt. b) heating the vegetable or part thereof to a temperature in the range 50 to 70° C., and c) a combination of a) and b); (ii) under-cooling to a core temperature of less than or equal to 5° C.; (iii) reducing the temperature to less than or equal to 18° C. The frozen vegetables, when thawed, possess a texture and appearance which closely resembles that of fresh vegetables.

U.S. Patent Publication No. 2005/0276890 generally describes a trough-type watertight drag conveyor for particulate material to be processed commences initial stages of the processing while the material is still within the trough. More specifically, in one significant application of the invention, treating liquid is utilized during the processing, this liquid serving further to assist in the conveyance and thereby minimize potential damage to certain materials. Paddles dragged along the trough essentially dam the material in relatively discrete batches. Despite being isolated in batches, the product flow is continuous, the batches being separated only by the thickness of the paddles. Conveyor speed is controlled to allow sufficient residence time of the material within the treating liquid in those instances where required. The paddles are restrained against lifting from the trough bottom to maintain a fairly intimate seal between the trough and paddles. The treating liquid is extracted from the material prior to discharge from the conveyor, and in its preferred form, the treating liquid is recirculated and reused.

None of the art described above addresses all of the issues that the present invention does.

### SUMMARY OF THE EMBODIMENTS

According to an aspect of the present invention, a method for preparing seafood alternatives from vegetation is provided. The method includes preparing the vegetation, wherein the preparing the vegetation includes cutting the vegetation into two or more pieces, brining the vegetation in a brining solution, cooking the vegetation, and marinating the vegetation in a marinade configured to give the vegetation a seafood flavor.

It is an object of the present invention to provide the method for preparing seafood alternatives from vegetation, wherein the vegetation is selected from the group consisting of: tomatoes; eggplants; carrots; and Jack fruit.

It is an object of the present invention to provide the method for preparing seafood alternatives from vegetation, wherein the preparing further includes peeling the vegetation.

It is an object of the present invention to provide the method for preparing seafood alternatives from vegetation, wherein the preparing further includes deseeding the vegetation.

It is an object of the present invention to provide the method for preparing seafood alternatives from vegetation, wherein the method further includes draining the brining solution.

It is an object of the present invention to provide the method for preparing seafood alternatives from vegetation, wherein the brining solution includes chemicals selected from the group consisting of: Calcium Chloride; Sodium Chloride; and/or any other suitable chemicals.

It is an object of the present invention to provide the method for preparing seafood alternatives from vegetation, wherein the method further includes freezing the vegetation prior to cooking the vegetation.

It is an object of the present invention to provide the method for preparing seafood alternatives from vegetation, wherein the method further includes thawing the vegetation prior to cooking the vegetation.

It is an object of the present invention to provide the method for preparing seafood alternatives from vegetation, wherein cooking the vegetation includes a cooking process selected from the group consisting of: steaming the vegetation; boiling the vegetation; and heating the vegetation using a moist heat cooking method.

It is an object of the present invention to provide the method for preparing seafood alternatives from vegetation, wherein the method further includes removing any excess water after cooking the vegetation.

It is an object of the present invention to provide the method for preparing seafood alternatives from vegetation, wherein the excess water is removed using centrifugation and/or any suitable type of oven.

It is an object of the present invention to provide the method for preparing seafood alternatives from vegetation, wherein the method further includes sorting the two or more pieces by size.

It is an object of the present invention to provide the method for preparing seafood alternatives from vegetation, wherein the method further includes removing excess marinade.

It is an object of the present invention to provide the method for preparing seafood alternatives from vegetation, wherein removing the excess marinade further includes pressing the vegetation to remove the excess marinade.

It is an object of the present invention to provide the method for preparing seafood alternatives from vegetation, wherein the marinade includes one or more ingredients selected from the group consisting of: soy sauce; tamari; mirin; one or more sweeteners; cornstarch; kuzu; tapioca; soy; konjac; plant cellulous; plant protein gels; sesame oil; algae oil; plant protein; monosodium glutamate (MSG); salt; seaweed; agar; pectin; calcium lactate; sodium alginate; yeast extracts; cultivated fish fats; cultivated fish protein; lab grown fish fats; lab grown fish protein; cultivated shellfish fats; cultivated shellfish protein; lab grown shellfish fats; lab grown shellfish protein; cultivated animal fats; cultivated animal protein; lab grown animal fats; and lab grown animal protein.

It is an object of the present invention to provide the method for preparing seafood alternatives from vegetation, wherein the method further includes pureeing the vegetation with marinade and any suitable stabilizers to create a sliceable vegetation block that can be pasteurized, made shelf stable, or frozen.

It is an object of the present invention to provide the method for preparing seafood alternatives from vegetation, wherein the method further includes packaging the vegetation after marinating the vegetation.

It is an object of the present invention to provide the method for preparing seafood alternatives from vegetation, wherein the method further includes, or can include, pasteurization, being made shelf stable, or freezing the packaged vegetation.

### BRIEF DESCRIPTION OF THE DRAWINGS

FIG. 1 shows a system for preparing tomatoes to have a non-tomato flavor, according to an embodiment of the present invention.

FIGS. 2-3 show a method for preparing tomatoes to have a non-tomato flavor, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The following embodiments describe systems and methods for cooking the flavor out of a tomato, completely removing the flavor while maintaining the structural shape of the cut tomato, and replacing the flavor with a new flavor. According to an embodiment, the flavor-removing process is accomplished by using CaCl to harden the tomato, which is then cooked tender. Other chemicals, such as Sodium Chloride, may also be used, according to some embodiments of the present invention. As a result of the cooking process, the flavor is removed. The resulting de-flavored tomato becomes the base of a product that is then marinated, flavored, and/or enhanced in such a way as to make the tomato look and taste like raw fish or meat. It is noted, however, that these systems and methods may also be used to treat, in the same or substantially similar way, other vegetables for similar results.

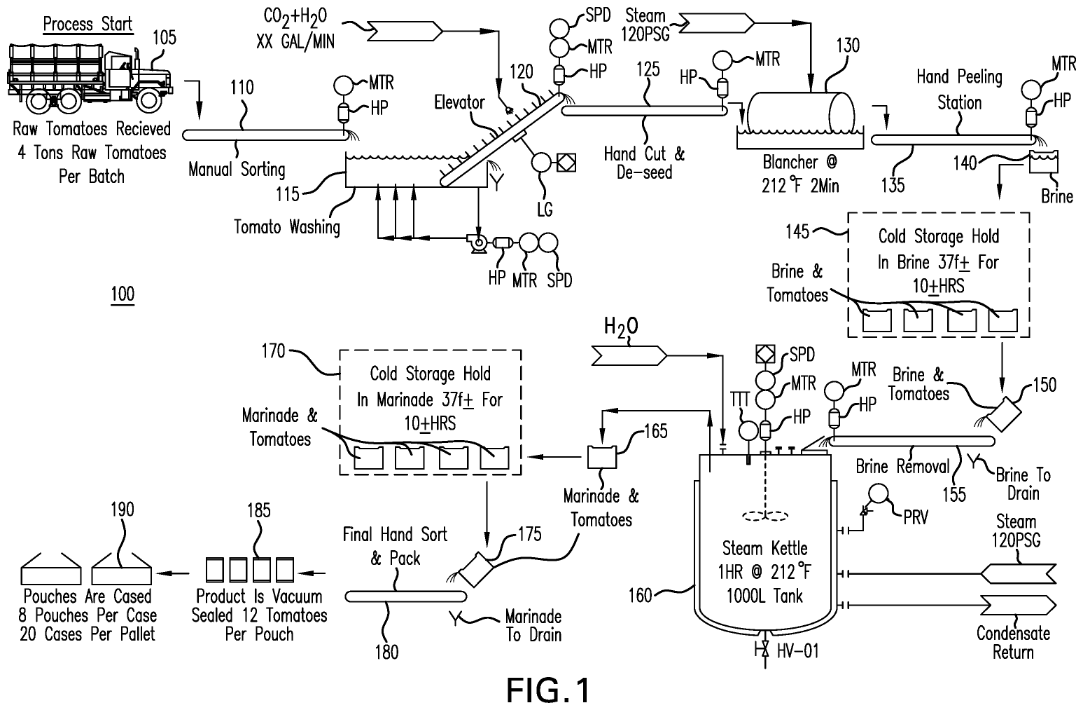

Referring now to FIG. 1, a system 100 for preparing tomatoes to have a non-tomato flavor and appearance is illustratively depicted, in accordance with an embodiment of the present invention.

According to an embodiment, raw tomatoes are received via one or more transport vessels 105. These transport vessels 105 may be cars, trucks, trains, planes, and/or any other suitable transport vessels 105.

According to an embodiment, once the raw tomatoes arrive, they are sorted at a sorting station 110. According to an embodiment, the sorting station 110 may be a manual sorting station and/or an automatic sorting station. According to an embodiment, once the tomatoes are sorted, the tomatoes are washed at a washing station 115. The washing station 115 may include one or more sprayers, one or more baths, and/or any other suitable washing apparatuses.

Once the tomatoes are sorted and washed, the tomatoes are transported, using one or more transportation systems 120 (e.g., a conveyor belt) to a cutting and de-seeding station 125. According to an embodiment, once the tomatoes are cut and de-seeded, they are steamed in a steamer 130 and/or peeled at a peeling station 135. According to various embodiments of the present invention, other methods of cooking may also be used, such as, e.g., boiling the vegetation, heating the vegetation using a moist heat cooking method, and/or any other suitable methods of cooking the vegetation.

According to an embodiment, the system 100 includes a brining solution 140. Once the tomatoes are steamed and peeled, the tomatoes are brined in the brining solution 140. The brining solution may include CaCl. It is noted, however, that other brining solutions may also be used. According to an embodiment, the system further includes a cold storage unit 145. According to an embodiment, while in the brining solution 140, the brine and tomato mixture 150 is cooled in the cold storage unit 145 and then drained at a brine draining unit 155.

According to an embodiment, the system 100 includes a steam unit 160. According to an embodiment, the steam unit 160 is a steam kettle. According to an embodiment, once the brine is drained, the tomatoes are steamed in the steam unit 160. Once steamed, the tomatoes are mixed with a marinade 165. The mixture of the tomatoes and marinade 175 are then cooled in a cold storage unit 170. Once cooled, the marinade is removed and sorted and packed at a sorting and packing station 180. Once in the packaging, the product is vacuum sealed at a vacuum sealer 185 and crated at the crating station 190.

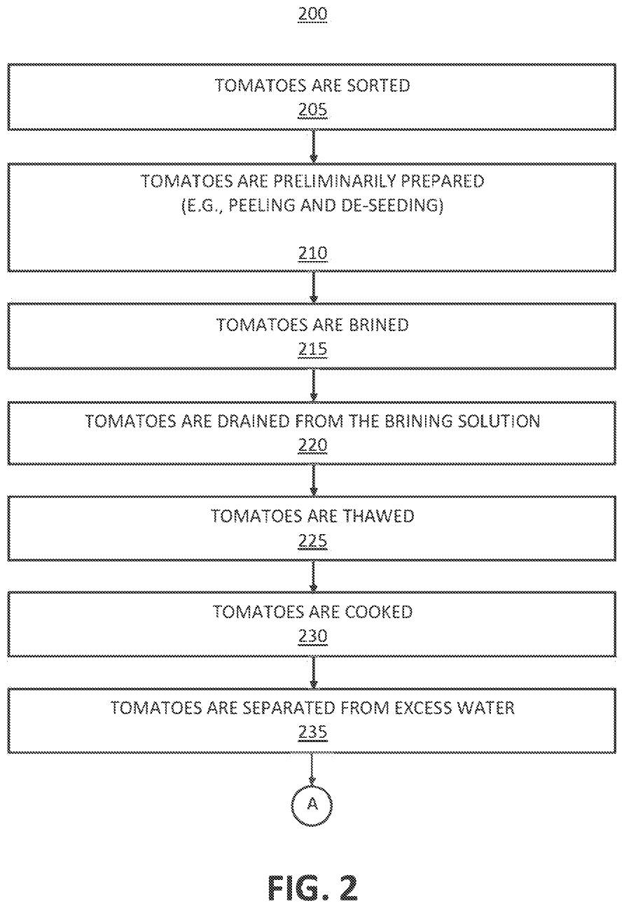

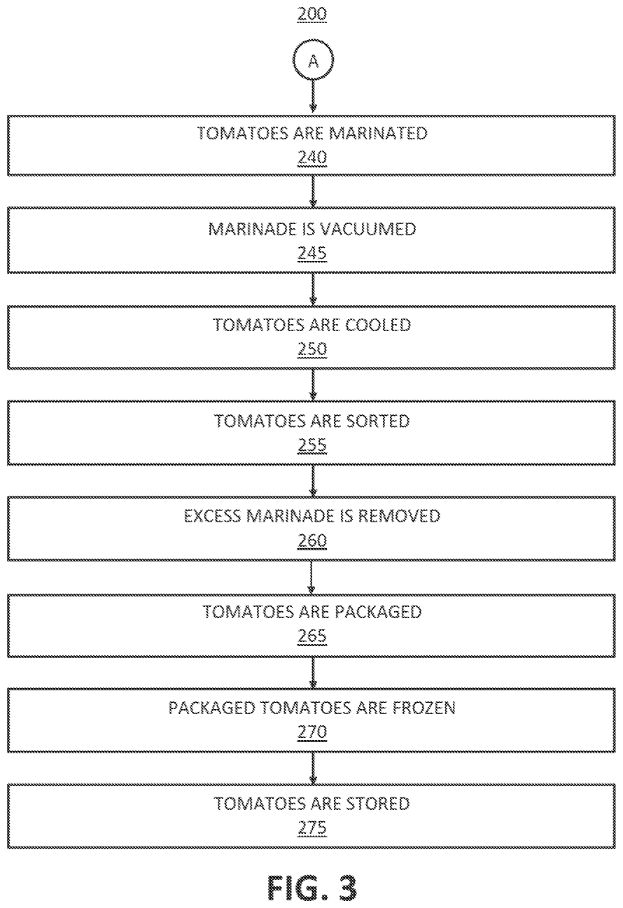

Referring now to FIGS. 2-3, a method 200 for preparing tomatoes to have a non-tomato flavor is illustratively depicted in accordance with an embodiment of the present invention.

At step 205, one or more tomatoes are sorted according to predetermined specifications. According to an embodiment, the tomatoes are Roma tomatoes. It is noted, however, that other suitable forms of tomatoes may be used. Tomatoes contain high levels of naturally-occurring glutamic acids, which are responsible for the savory flavor of meaty foods. According to an embodiment, the specifications by which the tomatoes are sorted may include size, shape, weight, color, texture, and/or any other suitable specifications while maintaining the spirit of the present invention. According to an embodiment, rather than tomatoes, other types of edible vegetation are used. This vegetation may include, e.g., eggplant, red pepper, beet, carrot, potato, butternut squash, jack fruit, watermelon, cucumber, celery root, sweet potato, large radish, and/or any other suitable vegetation.

At step 210, the tomatoes are preliminarily prepared. According to an embodiment, this preparation includes cutting the tomatoes and removing the seeds and skins of the tomatoes. According to an embodiment, the preparation process further includes washing the tomatoes. According to an embodiment, the preparation may include pureeing the vegetation.

At step 215, the tomatoes are brined in a brining solution. According to an embodiment, the brining solution is a CaCl solution. According to an embodiment, the tomatoes are brined until they have absorbed the brine completely.

At step 220, the tomatoes are drained from the brining solution. Once the tomatoes are drained of the CaCl, the tomatoes, at step 225, are then frozen. Freezing the tomatoes softens them, making them less brittle during cooking, creating a better finished product.

At step 225, the tomatoes are thawed. Then, at step 230, the tomatoes are cooked after freezing. According to an embodiment, the tomatoes are cooked frozen and not thawed prior to thawing. Depending on tomato size and variety, they are cooked in a mixture of water and tomatoes. According to an embodiment, the tomatoes are cooked in a steam jacketed kettle, although other devices may be used. According to an embodiment, the mixture of water and tomatoes is approximately 1-4 parts water to 1 part tomatoes, although the ratio may be different, depending on the state and type of the tomatoes and/or other vegetation. According to an embodiment, the cooking time varies from 0.5, 1, 1.5 or 2 hours, as needed, although other cooking times may also be used, while maintaining the spirit of the present invention. Cooking time variations can also depend on the size and type of kettle used. The ideal steam kettle will have a pressurized top that acts like an industrial pressure cooker, although other types of kettles may also be used. It is noted, however, that other forms of cooking the tomatoes may also be used, while maintaining the spirit of the present invention.

At step 235, the tomatoes, when cooked, are separated from any excess water. According to an embodiment, the method of removing the excess water includes draining the cooked tomatoes and placing them into a vacuum tumbler where excess water is vacuumed away. It is noted, however, that other forms of removing the excess water may also be used (e.g., a centrifuge), while maintaining the spirit of the present invention. For example, a centrifuge or oven may be used to remove the water.

At step 240, marinade is added to the tomatoes that may or may not be sorted or pureed. According to an embodiment, the marinade may include soy sauce (including powdered), tamari (including powdered), mirin, sweeteners, cornstarch, kuzu, tapioca, soy, konjac, plant cellulous, plant protein and/or plant protein gels, sesame oil, algae oil, plant protein (dry and/or gels), monosodium glutamate (MSG), salt, seaweed, agar, pectin, calcium lactate, sodium alginate, yeast extracts, cultivated or lab grown fish/shellfish/animal fats and/or protein, and/or any other suitable ingredients. According to an embodiment, the marinade includes a water binder. According to an embodiment, once the marinade is added to the tomatoes, the marinade, at step 245, is vacuumed, cold and/or hot marinated, into the cooked tomatoes. According to an embodiment, the marinade may or may not be pasteurized to various levels up to shelf stable in accordance with safe manufacturing procedures and delivery methods. According to an embodiment, along with the marinade, any suitable stabilizers may be added, creating a sliceable vegetation block that can be pasteurized, made shelf stable, or frozen.

Excess heat from the cooking step must be removed from the tomatoes before they are chilled or frozen. At step 250, the marinated tomatoes are removed to a blast chiller to remove the excess heat. It is noted, however, that other methods of removing the excess heat may also be used, while maintaining the spirit of the present invention. According to an embodiment, after the excess heat is removed, the marinated tomatoes are at or below approximately 70 degrees Fahrenheit. It is noted, however, that, depending on the tomatoes and/or vegetation used, other temperatures may also be suitable.

At step 255, the tomatoes may be sorted into whole, unbroken slices (called halves) and smaller pieces that have been damaged during processing. It is noted, however, that the tomatoes may be sorted into any suitable shape and size. It is further noted that, according to some embodiments, the tomatoes are not sorted. According to some embodiment, the tomatoes may be pureed.

At step 260, the sorted tomato halves and pieces are conveyor pressed to adjust moisture by removing excess marinade. It is noted, however, that other methods of removing excess marinade may also be used, while maintaining the spirit of the present invention.

At step 265, the tomato halves and pieces that have had excess moisture removed are stacked and/or placed into plastic bags that are vacuum sealed before pasteurization and/or freezing. It is noted, however, other suitable containers may be used, while maintaining the spirit of the present invention. Once the tomato halves and/or pieces are packaged, the packaged tomato halves, at step 270, are frozen. According to an embodiment, rather than being frozen, the tomatoes, at step 275, are stored and handled in accordance with desired results of a pasteurization process used.

According to an embodiment, the finished product is configured to look and taste like raw tuna, acting as a plant-based substitution for raw tuna to use in all applicable sushi applications. It is noted, however, that the finished product may be prepared to act as a substitute (in texture and/or flavor) for any suitable food which can be mimicked using the method 200.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for preparing seafood alternatives from vegetation, comprising:
preparing the vegetation,
wherein the preparing the vegetation includes cutting the vegetation into two or more pieces;
brining the vegetation in a brining solution;
cooking the vegetation; and
marinating the vegetation in a marinade configured to give the vegetation a seafood flavor.

2. The method as recited in claim 1, wherein the vegetation is selected from the group consisting of: tomatoes; eggplants; carrots; and Jack fruit.

3. The method as recited in claim 1, wherein the preparing further includes peeling the vegetation.

4. The method as recited in claim 1, wherein the preparing further includes deseeding the vegetation.

5. The method as recited in claim 1, further comprising draining the brining solution.

6. The method as recited in claim 1, wherein the brining solution includes Calcium Chloride.

7. The method as recited in claim 1, further comprising freezing the vegetation prior to cooking the vegetation.

8. The method as recited in claim 7, further comprising thawing the vegetation prior to cooking the vegetation.

9. The method as recited in claim 1, wherein cooking the vegetation includes a cooking process selected from the group consisting of: steaming the vegetation; boiling the vegetation; and heating the vegetation using a moist heat cooking method.

10. The method as recited in claim 9, further comprising removing any excess water after cooking the vegetation.

11. The method as recited in claim 10, wherein the excess water is removed using centrifugation.

12. The method as recited in claim 1, further comprising sorting the two or more pieces by size.

13. The method as recited in claim 1, further comprising removing excess marinade.

14. The method as recited in claim 13, wherein removing the excess marinade further includes pressing the vegetation to remove the excess marinade.

15. The method as recited in claim 1, wherein the marinade includes one or more ingredients selected from the group consisting of: soy sauce; tamari; mirin; one or more sweeteners; cornstarch; kuzu; tapioca; soy; konjac; plant cellulous; plant protein gels; sesame oil; algae oil; plant protein; monosodium glutamate (MSG); salt; seaweed; agar; pectin; calcium lactate; sodium alginate; yeast extracts; cultivated fish fats; cultivated fish protein; lab grown fish fats; lab grown fish protein; cultivated shellfish fats; cultivated shellfish protein; lab grown shellfish fats; lab grown shellfish protein; cultivated animal fats; cultivated animal protein; lab grown animal fats; and lab grown animal protein.

16. The method as recited in claim 1, further comprising packaging the vegetation after marinating the vegetation.

17. The method as recited in claim 15, further comprising freezing the packaged vegetation.

18. The method as recited in claim 1, wherein preparing the vegetation further includes:
pureeing the vegetation with the marinade and one or more stabilizers.
